(19) United States
(12) Patent Application Publication
(10) Pub. No.: US 2017/0175974 A1
(43) Pub. Date: Jun. 22, 2017

(54) ILLUMINATION MOUDLE FOR CREATING LATERAL RECTANGULAR ILLUMINATION WINDOW

(71) Applicant: LIGITEK ELECTRONICS CO., LTD., NEW TAIPEI CITY (TW)

(72) Inventors: HSIAO-WEN LEE, KAOHSIUNG CITY (TW); I-HSIN TUNG, NEW TAIPEI CITY (TW)

(21) Appl. No.: 14/974,359

(22) Filed: Dec. 18, 2015

(51) Int. Cl. F21V 5/04

(52) U.S. Cl. CPC F21V 5/04; F21Y 2115/10; F21Y 2115/30

(57) ABSTRACT

Disclosed is an illumination module for creating lateral rectangular illumination window which includes a substrate, at least one light-emitting element, and an optical lens. The light-emitting element is mounted on the substrate for generating visible light or invisible light, and having an optical axis. The optical lens is arranged on the substrate to cover the light-emitting element. The optical lens includes a light-entrance surface and a light-exiting surface opposite to the entrance surface, and the light-exiting surface has a light emission center. The light-exiting surface of the optical lens can be configured to direct a beam of light generated by the light-emitting element to output along the optical axis and pass through the light emission center to create a lateral rectangular illumination window. Whereby, the components of a camera can be reduced, and image distortion caused by compressing and converting can be prevented.

### BACKGROUND OF THE INVENTION

1. Field of the Invention

The instant disclosure relates to an illumination module, in particular, to an illumination module for creating lateral rectangular illumination window.

2. Description of Related Art

Nowadays, surveillance cameras are very widely used in places such as factories, dormitories, stores, buildings, and gateways of community housings, or secret areas, to monitor human activities and save information under visible light or invisible light conditions for the uses of trace and authentication. Thereby, those who having bad intentions will be threaten and warned against the illegal acts, and thus the public can be ensured from crimes.

In the surveillance cameras there is arranged at least one LED (Light Emitting Diode) or laser illumination device to assist image capture. Thus, the surveillance cameras can start monitoring under poor lighting conditions. In general, the illumination device can generate an infrared light having a wavelength ranging from about approximately 750 to 1000 nm or a laser beam having a wavelength ranging from about 800 to 1000 nm. These invisible lights can be used to provide a long distance illumination. However, a common problem of the surveillance cameras is poor lighting at night time.

The output illumination pattern generated by LED or laser illumination device is circular symmetric, and the intensity in the central region is always greater than that in the peripheral region. This may result in an unclear shooting position on the peripheral of the target object.

Further, to match a camera aspect ratio of 4:3 or 16:9. The conventional lens mechanism must have a rectangular opening with an aspect ratio of 4:3 or 16:9, thus the resulting image of the target object can be converted to a rectangular image data using a photoelectric conversion unit. In addition, the light illumination range, window, and aspect ratio of the illumination device cannot meet the standard 4:3 aspect ratio of imaging apparatus or the standard 16:9 aspect ratio of high definition TV (HDTV). Thus, there is always some distortion of the captured image of the target object.

The light source can generate illumination pattern. The captured images are compressed into the image frames with a preset aspect ratio via an image server. However, during the compression process, there may be compression artifacts generated anywhere of the image frame. Thus, after image decompression, there will not be the originally captured image but the image having artifacts displayed on TV or monitor.

In summary, there is an urgent need of technologies used to convert a circular symmetric illumination pattern into an asymmetric illumination pattern with an aspect ratio of 4:3 or 16:9.

### SUMMARY OF THE INVENTION

For the purposes of adjustment of light projection angle and illumination pattern. The object of the instant disclosure is to provide an efficient illumination module for creating lateral rectangular illumination window without substantial light losses, and can be miniaturized.

In order to achieve the aforementioned objects, according to an embodiment of the instant disclosure, the illumination module includes a substrate, at least one light-emitting element, and an optical lens. The substrate includes an installation surface. The light-emitting element is mounted on the installation surface of substrate, and having an optical axis. The optical lens is mounted on the installation surface of substrate to cover the light-emitting element. The optical lens includes a light-entrance surface and a light-exiting surface opposite to the light-entrance surface, wherein the length direction of the light-entrance surface is parallel to an X-axis, the width direction of the light-entrance surface is parallel to a Y-axis which is perpendicular to the X-axis, and a direction perpendicular to the light-entrance surface is parallel to a Z-axis. The light-exiting surface of the optical lens consists of at least two curved surfaces of different curvature, and having a light emission center. The light-exiting surface of the optical lens is protruded along the Z-axis and away from the light-entrance surface, and is configured to direct a beam of light generated by the light-emitting element to output along the optical axis and pass through the light emission center to create a lateral rectangular illumination window. The lateral rectangular illumination window has an aspect ratio of between 1.03 and 2.08.

In one embodiment, the light-emitting element is configured to generate a visible white light having a color temperature ranging from about 2700K to 7000K.

In one embodiment, the light-emitting element is configured to generate an infrared light having a wavelength ranging from about 750 to 1000 nm.

In one embodiment, the light-emitting element is an LED chip.

In one embodiment, the light-emitting element is a laser element configured to generate a laser beam having a wavelength ranging from about 800 to 1000 nm.

In one embodiment, the laser element is an LD (Laser Diode) chip.

In one embodiment, the light-emitting element is square.

In one embodiment, the light-emitting elements are arranged in a non-rectangular array.

In one embodiment, the light-emitting elements are arranged in a square array.

In one embodiment, the substrate is a metal substrate, a ceramic substrate, or a glass fiber substrate.

In one embodiment, the metal substrate is made of copper, copper alloy, aluminum, aluminum alloy, magnesium alloy, aluminum silicon carbide, or carbon composition.

In one embodiment, the ceramic substrate is made of aluminum oxide, aluminum nitride, zirconium oxide, silicon carbide, hexagonal boron nitride, or fluorinated carbon.

In one embodiment, between the optical lens, the substrate, and the light-emitting element, there is no air gap.

In one embodiment, the optical lens is asymmetric.

In one embodiment, the light-exiting surface of the optical lens is an aspheric surface, a cambered surface, a paraboloid surface, a hyperboloid surface, or a free-form surface.

In one embodiment, the optical lens is made of epoxy, acrylic resin, silicon resin, or silicone.

The benefits of the present invention include: The surveillance camera system utilizing the illumination module can create a lateral rectangular illumination window having an aspect ratio of between 1.03 and 1.63 or an aspect ratio of between 1.48 and 2.08. Thereby, rectangular images can be directly captured by a camera, and the peripheral of the target object can be clearly shot. In addition, the components of a camera can be reduced, and image distortion caused by compressing and converting can be prevented.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 schematically depicts an illumination module for creating lateral rectangular illumination window according to a first embodiment of the present invention.

FIG. 2 schematically depicts an illumination module for creating lateral rectangular illumination window according to a second embodiment of the present invention.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### First Embodiment

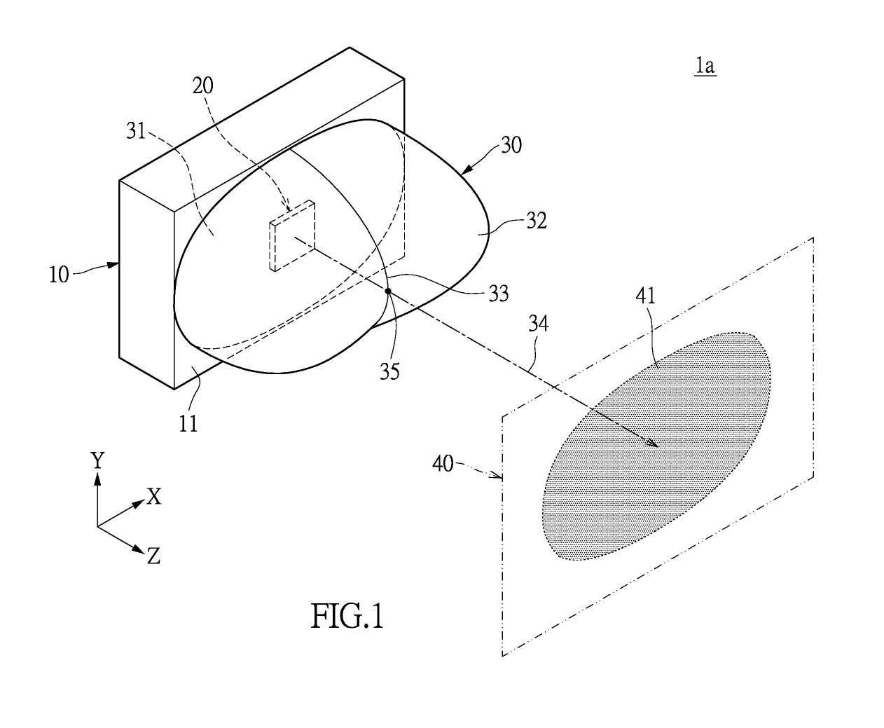

Please refer to FIG. 1. This is a perspective diagram showing an illumination module for creating lateral rectangular illumination window according to a first embodiment of the present invention. The illumination module 1a includes a substrate 10, a light-emitting element 20, and an optical lens 30.

The substrate 10 includes an installation surface 11 for arrangement of the light-emitting element 20. For the instant embodiment, the substrate 10 can be but not limited to a metal substrate, a ceramic substrate, or a glass fiber substrate (e.g., FR-4, FR-5, G-10, and G-11). Specifically, the metal substrate is made of copper, copper alloy, aluminum, aluminum alloy, magnesium alloy, aluminum silicon carbide, or carbon composition. The ceramic substrate is made of aluminum oxide, aluminum nitride, zirconium oxide, silicon carbide, hexagonal boron nitride, or fluorinated carbon. Preferably, on a surface opposite to the installation surface 11 of the substrate 10 there can be arranged a heat sink (not shown) to dissipate heat from the light-emitting element 20, wherein the heat sink can be made by die-casting, aluminum extruding, or punching.

The light-emitting element 20 is mounted on the installation surface 11 of the substrate 10. The light-emitting element 20 is square and has an optical axis 34. For the instant embodiment, the light-emitting element 20 is configured to generate a visible white light having a color temperature ranging from about 2700K to 7000K, an infrared light having a wavelength ranging from about approximately 750 to 1000 nm, or a laser beam having a wavelength ranging from about 750 to 1000 nm. Specific examples of the light-emitting element 20 include LED chip for generating visible light, LED chip for generating invisible light (e.g., infrared emitting diode and laser diode), and laser (e.g., liquid state laser, solid state laser, and gas laser element). The solid state laser can be a LD chip.

The optical lens 30 can be made of moisture-resistant curable sealer. The optical lens 30 is mounted on the installation surface 11 of the substrate 10 to cover the light-emitting element 20. To reduce light refraction and loss, the optical lens 30 is a primary optical lens. Specifically, the optical lens 30 is formed on the substrate 10 by overmolding such that there is no air gap between the optical lens 30, the substrate 10, and the light-emitting element 20. For the instant embodiment, the optical lens 30 can be made of transparent material such as epoxy, acrylic resin, silicon resin, and silicone, however not restricted thereto.

In more details, the optical lens 30 includes a light-entrance surface 31 and a light-exiting surface 32 opposite to the entrance surface 31. The length direction of the light-entrance surface 31 is parallel to an X-axis, the width direction of the light-entrance surface 31 is parallel to a Y-axis which is perpendicular to the X-axis, and a direction perpendicular to the light-entrance surface 31 is parallel to a Z-axis. The light-exiting surface 32 is protruded along the Z-axis and away from the light-entrance surface 31.

It is worthy to note that the light-exiting surface 32 of the optical lens 30 consists of at least two curved surfaces 33 of different curvature and has a light emission center 35. Thereby, a beam of light generated by the light-emitting element 20 can be directed by the light-exiting surface 32 and outputted to create a lateral rectangular illumination window 41 in an illuminated target region 40 along the optical axis 34 and pass through the light emission center 35. The lateral rectangular illumination window 41 has an aspect ratio of between 1.03 and 1.63, preferably 1.33 (4:3) or an aspect ratio of between 1.48 and 2.08, preferably 1.78 (16:9). Here, the term “aspect ratio” refers to the ratio of the maximum cross-sectional dimension LED assembly area with the maximum cross-sectional dimension perpendicular to the maximum cross-sectional dimension.

The optical lens 30 is asymmetric. The light-exiting surface 32 of the optical lens 30 can be an aspheric surface, a cambered surface, a paraboloid surface, a hyperboloid surface, or a free-form surface.

### Second Embodiment

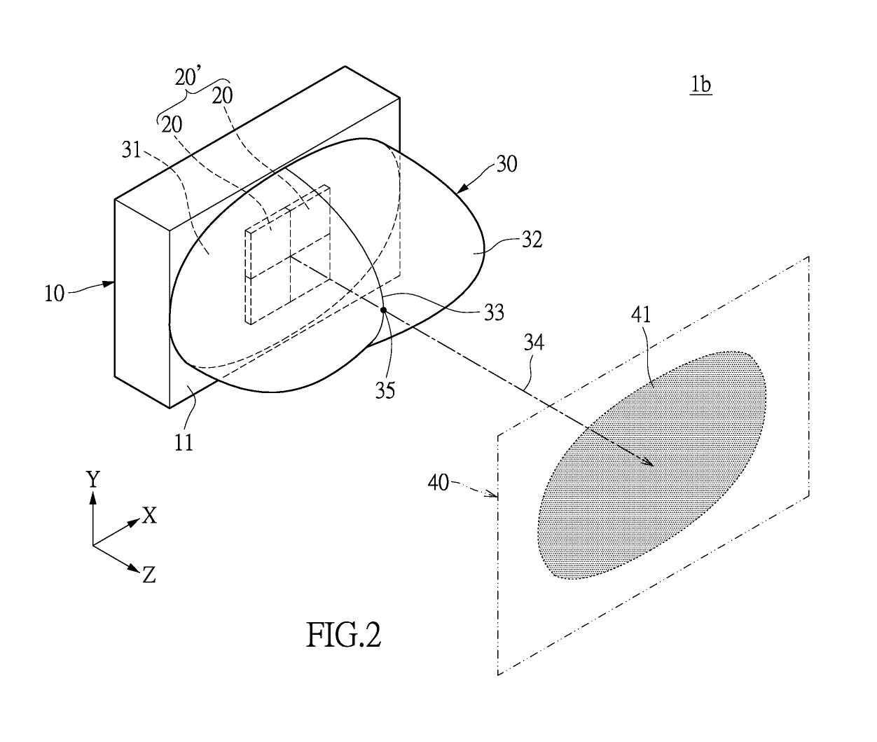

Please refer to FIG. 2. This is a perspective diagram showing an illumination module for creating lateral rectangular illumination window according to a second embodiment of the present invention. The illumination module 1b includes a substrate 10, a plurality of light-emitting elements 20, and an optical lens 30. Compared with the first embodiment, the light-emitting elements 20 are arranged in a non-rectangular array 20′. For example, the illumination module 1b, as shown in FIG. 2, includes four light-emitting elements 20 arranged in a square array 20′, of which each two light-emitting elements 20 are in a row.

Please note that the square array 20′ shown in FIG. 2 consists of four light-emitting elements 20, but embodiments are not limited to any particular number of light-emitting elements 20. In various embodiments, the square array 20′ may consist of nine light-emitting elements 20, and each three light-emitting elements 20 are in a row.

The substrate 10 includes an installation surface 11 for arrangement of the light-emitting element 20. For the instant embodiment, the substrate 10 can be but not limited to a metal substrate, a ceramic substrate, or a glass fiber substrate (e.g., FR-4, FR-5, G-10, and G-11). Specifically, the metal substrate is made of copper, copper alloy, aluminum, aluminum alloy, magnesium alloy, aluminum silicon carbide, or carbon composition. The ceramic substrate is made of aluminum oxide, aluminum nitride, zirconium oxide, silicon carbide, hexagonal boron nitride, or fluorinated carbon. Preferably, on a surface opposite to the installation surface 11 of the substrate 10 there can be arranged a heat sink (not shown) to dissipate heat from the light-emitting element 20, wherein the heat sink can be made by die-casting, aluminum extruding, or punching.

The square array 20′ is mounted on the installation surface 11 of the substrate 10, and has an optical axis 34. For the instant embodiment, each light-emitting element 20 of the square array 20′ is configured to generate a visible white light having a color temperature ranging from about 2700K to 7000K, an infrared light having a wavelength ranging from about 750 to 1000 nm, or a laser beam having a wavelength ranging from about 800 to 1000 nm. Specific examples of the light-emitting element 20 include LED chip for generating visible light, LED chip for generating invisible light (e.g., infrared emitting diode and laser diode), and laser (e.g., liquid state laser, solid state laser, and gas laser element). The solid state laser can be a LD chip.

The optical lens 30 can be made of moisture-resistant curable sealer. The optical lens 30 is mounted on the installation surface 11 of the substrate 10 to cover the light-emitting elements 20. To reduce light refraction and loss, the optical lens 30 is a primary optical lens. Specifically, the optical lens 30 is formed on the substrate 10 by overmolding such that there is no air gap between the optical lens 30, the substrate 10, and the light-emitting elements 20. For the instant embodiment, the optical lens 30 can be made of transparent material such as epoxy, acrylic resin, silicon resin, and silicone, however not restricted thereto.

In more details, the optical lens 30 includes a light-entrance surface 31 and a light-exiting surface 32 opposite to the entrance surface 31. The length direction of the light-entrance surface 31 is parallel to an X-axis, the width direction of the light-entrance surface 31 is parallel to a Y-axis which is perpendicular to the X-axis, and a direction perpendicular to the light-entrance surface 31 is parallel to a Z-axis. The light-exiting surface 32 is protruded along the Z-axis and away from the light-entrance surface 31.

It is worthy to note that the light-exiting surface 32 of the optical lens 30 consists of at least two curved surfaces 33 of different curvature and has a light emission center 35. Thereby, a beam of light generated by the light-emitting element 20 can be directed by the light-exiting surface 32 and outputted to create a lateral rectangular illumination window 41 in an illuminated target region 40 along the optical axis 34 and pass through the light emission center 35. The lateral rectangular illumination window 41 has an aspect ratio of between 1.03 and 1.63, preferably 1.33 (4:3) or an aspect ratio of between 1.48 and 2.08, preferably 1.78 (16:9). Here, the term “aspect ratio” refers to the ratio of the maximum cross-sectional dimension LED assembly area with the maximum cross-sectional dimension perpendicular to the maximum cross-sectional dimension.

The optical lens 30 is asymmetric. The light-exiting surface 32 of the optical lens 30 can be an aspheric surface, a cambered surface, a paraboloid surface, a hyperboloid surface, or a free-form surface.

Base on the above, the surveillance camera system utilizing the illumination module can create a lateral rectangular illumination window 41 having an aspect ratio of between 1.03 and 1.63 or an aspect ratio of between 1.48 and 2.08. Thereby, rectangular images can be directly captured by a camera, and the peripheral of the target object can be clearly shot. In addition, the components of a camera can be reduced, and image distortion caused by compressing and converting can be prevented.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

1. An illumination module for creating a lateral rectangular illumination window, comprising:
a substrate having an installation surface;
at least one light-emitting element having an optical axis, and being mounted on the installation surface of the substrate; and
an optical lens mounted on the installation surface of the substrate to cover the light-emitting element, wherein the optical lens includes a light-entrance surface and a light-exiting surface opposite to the light-entrance surface, wherein the length direction of the light-entrance surface is parallel to an X-axis, the width direction of the light-entrance surface is parallel to a Y-axis which is perpendicular to the X-axis, and a direction perpendicular to the light-entrance surface is parallel to a Z-axis;
wherein the light-exiting surface of the optical lens consists of at least two curved surfaces of different curvature and has a light emission center, wherein the light-exiting surface protrudes along the Z-axis and away from the light-entrance surface, and wherein the light-exiting surface is configured to direct a beam of light generated by the light-emitting element to output along the optical axis and the beam of light passes through the light emission center to create the lateral rectangular illumination window;
wherein the lateral rectangular illumination window has an aspect ratio of between 1.03 and 2.08 excluding 1.25, 1.5, 1.912, and 2.

2. The illumination module according to claim 1, wherein the light-emitting element is configured to generate a visible white light having a color temperature ranging from about 2700K to 7000K.

3. The illumination module according to claim 1, wherein the light-emitting element is configured to generate an infrared light having a wavelength ranging from about 750 to 1000 nm.

4. The illumination module according to claim 2, wherein the light-emitting element is an LED chip.

5. The illumination module according to claim 3, wherein the light-emitting element is an LED chip.

6. The illumination module according to claim 1, wherein the light-emitting element is a laser element configured to generate a laser beam having a wavelength ranging from about 800 to 1000 nm.

7. The illumination module according to claim 6, wherein the laser element is an LD chip.

8. The illumination module according to claim 1, wherein the light-emitting element is square.

9. (canceled)

10. The illumination module according to claim 1, further comprising a plurality of light-emitting elements, and the light-emitting elements are arranged in a square array.

11. The illumination module according to claim 1, wherein the substrate is a metal substrate, a ceramic substrate, or a glass fiber substrate.

12. The illumination module according to claim 11, wherein the metal substrate is made of copper, copper alloy, aluminum, aluminum alloy, magnesium alloy, aluminum silicon carbide, or carbon composition.

13. The illumination module according to claim 11, wherein the ceramic substrate is made of aluminum oxide, aluminum nitride, zirconium oxide, silicon carbide, hexagonal boron nitride, or fluorinated carbon.

14. The illumination module according to claim 1, wherein between the optical lens, the substrate, and the light-emitting element, there is no air gap.

15. The illumination module according to claim 1, wherein the optical lens is asymmetric.

16. The illumination module according to claim 15, wherein the light-exiting surface of the optical lens is an aspheric surface, a cambered surface, a paraboloid surface, a hyperboloid surface, or a free-form surface.

17. The illumination module according to claim 16, wherein the optical lens is made of epoxy, acrylic resin, silicon resin, or silicone.

18. The illumination module according to claim 1, wherein the aspect ratio of the lateral rectangular illumination window is between 1.03 and 1.63 excluding 1.25 and 1.5.

19. The illumination module according to claim 1, wherein the aspect ratio of the lateral rectangular illumination window is between 1.48 and 2.08 excluding 1.5, 1.912, and 2.

20. The illumination module according to claim 1, wherein the aspect ratio of the lateral rectangular illumination window is 1.03, 1.48, 1.63, or 2.08.
